(19) United States
(12) Patent Application Publication
(10) Pub. No.: US 2020/0358205 A1
(43) Pub. Date: Nov. 12, 2020

(54) ANTENNA AND METHOD OF FORMING THE SAME

(71) Applicant: Agency for Science, Technology and Research, Singapore (SG)

(72) Inventors: Mei SUN, Singapore (SG); Xianming QING, Singapore (SG); - NASIMUDDIN, Singapore (SG); Zhining CHEN, Singapore (SG)

(21) Appl. No.: 16/766,159

(22) PCT Filed: Nov. 28, 2018
(86) PCT No.: PCT/SG2018/050581

§ 371 Date: May 21, 2020

(30) Foreign Application Priority Data
Nov. 30, 2017 (SG) 10201709962R

(51) Int. Cl. H01Q 21/06; H01Q 1/38; H01Q 1/48

(52) U.S. Cl. CPC H01Q 21/065; H01Q 1/48; H01Q 1/38

(57) ABSTRACT

Various embodiments may relate to an antenna. The antenna may include a substrate. The antenna may further include a radiator in contact with the substrate, the radiator including a plurality of grid cells. The antenna may also include a ground structure spaced from the radiator, the ground structure including a plurality of apertures. The antenna may additionally include a plurality of feeding couplers connected to the radiator, each of the plurality of feeding couplers passing through a respective aperture of the plurality of apertures.

### CROSS-REFERENCE TO RELATED APPLICATION

This application claims the benefit of priority of Singapore application No. 10201709962R filed on Nov. 30, 2017, the contents of it being hereby incorporated by reference in its entirety for all purposes.

### TECHNICAL FIELD

Various embodiments relate to an antenna. Various embodiments relate to a method of forming an antenna.

### BACKGROUND

Antennas with full-range beam scanning or switched beams are very useful for millimeter wave (mmW) applications such as WiFi at 60 GHz, automotive radar at 77 GHz, satellite or imaging radar at 94 GHz. Low cost, planar, and high gain antenna solutions are desired or required for these applications. For example, the antennas for wireless local area network/wireless personal area network (WLAN/WPAN) communication systems are required to have high directivity of around 20 dBi and with different beam scanning angle ranges. A number of beam scanning antenna technologies have been reported.

Existing antennas with full-range beam scanning or switched beam have relied on phase shifters connected to each antenna element or a small sub-array to achieve phase array. However, such implementations are complex in configuration, and are costly, especially in the operating mmW band. Switched beam antenna configurations using butler matrix structures are unable to achieve higher antenna gain. The complex and larger feeding matrix structures required further limit applications for butler matrix structures.

### SUMMARY

Various embodiments may relate to an antenna. The antenna may include a substrate. The antenna may further include a radiator in contact with the substrate, the radiator including a plurality of grid cells. The antenna may also include a ground structure spaced from the radiator, the ground structure including a plurality of apertures. The antenna may additionally include a plurality of feeding couplers connected to the radiator, each of the plurality of feeding couplers passing through a respective aperture of the plurality of apertures.

Various embodiments may relate to a method of forming an antenna. The method may include forming a radiator in contact with a substrate, the radiator including a plurality of grid cells. The method may also include forming a ground structure spaced from the radiator, the ground structure including a plurality of apertures. The method may additionally include forming a plurality of feeding couplers connected to the radiator, each of the plurality of feeding couplers passing through a respective aperture of the plurality of apertures.

### BRIEF DESCRIPTION OF THE DRAWINGS

The invention will be better understood with reference to the detailed description when considered in conjunction with the non-limiting examples and the accompanying drawings, in which:

FIG. 1 is a general illustration of an antenna according to various embodiments.

FIG. 2A shows an antenna with 17 feeding nodes according to various embodiments.

FIG. 2B shows the two-dimensional (2-D) radiation patterns of the antenna with 17 feed ports according to various embodiments at 93 GHz.

FIG. 3A shows an antenna using substrate integrated waveguide (SIW) feeding structures according to various embodiments. The inset of FIG. 3A shows a schematic of a substrate integrated waveguide (SIW) feeding structure according to various embodiments.

FIG. 3B is a cross-sectional view of the antenna shown in FIG. 3A according to various embodiments. The inset of FIG. 3B shows a schematic of a feeding via according to various embodiments.

FIG. 4A shows a plot of a scattering parameter (S-parameter, in decibels or dB) as a function of frequency (in gigahertz or GHz) showing the simulated performance of the antenna shown in FIGS. 3A-B according to various embodiments.

FIG. 4B shows 3-dimensional (3-D) radiation patterns for different ports of the antenna shown in FIGS. 3A-B according to various embodiments at 93 GHz.

FIG. 4C shows 2-dimensional (2-D) radiation patterns (with realized gain values) of the antenna shown in FIGS. 3A-B according to various embodiments in the xz-plane at 93 GHz.

FIG. 5 shows a top view and a three-dimensional (3-D) view of an antenna using substrate integrated waveguide (SIW) power divider (PD) feeding structures according to various embodiments.

FIG. 6A shows a plot of a scattering parameter (S-parameter, in decibels or dB) as a function of frequency (in gigahertz or GHz) showing the simulated performance of the antenna shown in FIG. 5 according to various embodiments.

FIG. 6B shows 2-dimensional (2-D) radiation patterns (with realized gain values) of the antenna shown in FIG. 5 according to various embodiments in the xz-plane at 93 GHz.

FIG. 7 shows (a) an antenna including one or more meta-surfaces on top of the radiator according to various embodiments, and (b) an antenna including an embedded meta-surface between the radiator and the ground structure or plane according to various embodiments.

FIG. 8 shows the top view and the 3-dimensional (3-D) view of an antenna for emitting circularly polarized (CP) beams according to various embodiments.

FIG. 9A shows a plot of a scattering parameter (S-parameter, in decibels or dB) as a function of frequency (in gigahertz or GHz) showing the simulated performance of the antenna shown in FIG. 8 according to various embodiments.

FIG. 9B shows 2-dimensional (2-D) radiation patterns (with realized gain values) of the antenna shown in FIG. 8 according to various embodiments in the xz-plane at 93 GHz.

FIG. 9C shows the axial ratio pattern of the antenna shown in FIG. 8 according to various embodiments in the xz-plane at 93 GHz.

FIG. 10 is a schematic illustrating a method of forming an antenna according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the methods or antennas are analogously valid for the other methods or antennas. Similarly, embodiments described in the context of a method are analogously valid for an antenna, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may also be used herein to mean that the deposited material may be formed “indirectly on” the implied side or surface with one or more additional layers being arranged between the implied side or surface and the deposited material. In other words, a first layer “over” a second layer may refer to the first layer directly on the second layer, or that the first layer and the second layer are separated by one or more intervening layers.

The antenna as described herein may be operable in various orientations, and thus it should be understood that the terms “top”, “topmost”, “bottom”, “bottommost” etc., when used in the following description are used for convenience and to aid understanding of relative positions or directions, and not intended to limit the orientation of the antenna.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

There is a need for a compact and low-cost planar full-range switched beam antenna, in particular, for mmW applications.

Various embodiments may seek to address one or more issues facing conventional antenna structures. Various embodiments may seek to provide a compact and low-cost planar full-range switched beam antenna.

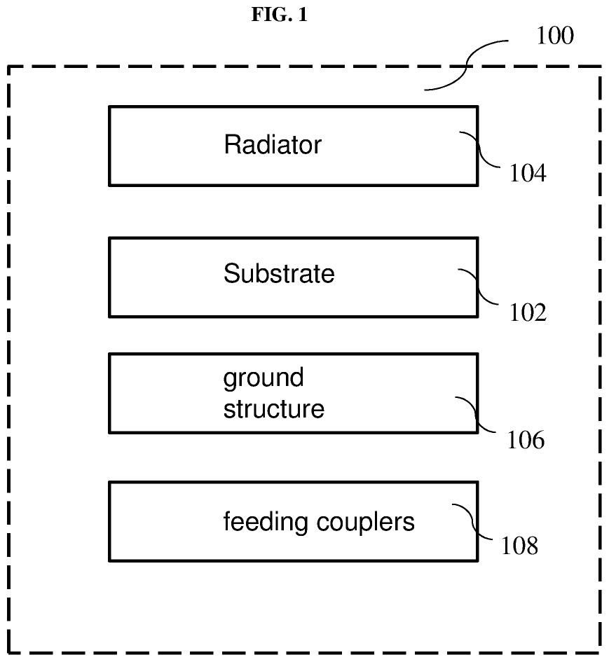

FIG. 1 is a general illustration of an antenna 100 according to various embodiments. The antenna may be referred to as a grid array antenna (GAA) or a microstrip GAA. The antenna 100 may include a substrate 102. The antenna 100 may further include a radiator 104 in contact with the substrate 102, the radiator including a plurality of grid cells. The antenna 100 may also include a ground structure 106 spaced from the radiator, the ground structure 106 including a plurality of apertures. The antenna 100 may additionally include a plurality of feeding couplers 108 connected to the radiator 104, each of the plurality of feeding couplers 108 passing through a respective aperture of the plurality of apertures.

In other words, the antenna 100 may include a radiator 104 supported by a substrate 102. The radiator 104 may consist of grids. The antenna 100 may also include a ground structure 106 which has a number of apertures. A feeding coupler 108 may pass through each aperture to electrically connect to the radiator.

Various embodiments may provide a grid array antenna. In various embodiments, the grid antenna may have planar full-range circularly polarized switched beam capability. Compared with the traditional phase array, various embodiments may be able to provide the necessary phase shift for generating the beam scanning. As such, various embodiments may not require phase shifters. Various embodiments may be advantageous for millimeter wave (mmW) beam steering antenna applications, since the phase shifter may not be available at 60 GHz and higher frequencies. Compared with the bulky three dimensional (3-D) traditional lens design or transmit array antenna, various embodiments may have a simplified configuration with low profile. Compared with a switched beam antenna using butler matrix structure, various embodiments may have a reduced size (or footprint), and enhanced gain.

The radiator (also referred to as a grid array) 104 may be printed onto a substrate 102 with a ground structure (also referred to as a ground plane) 106, and may be fed by a feeding coupler 108 through a ground aperture. In various embodiments, the ground structure 106 may be a plate. The ground structure 106 may be part of the substrate 102. The ground structure 106 may be configured to be connected to ground.

In various embodiments, the substrate 104 may include a suitable dielectric. The substrate 102 may be a dielectric substrate. In various embodiments, the substrate 102 may be a hydrocarbon/ceramics composite substrate. In various other embodiments, the substrate 102 may be a polytetrafluoroethylene (PTFE)/ceramics composite substrate. In yet various other embodiments, the substrate may include air, wood, glass, liquid crystal polymer, or any other suitable materials.

The radiator 104 may include a plurality of feeding nodes. A feeding node may also be referred to as a feeding point. Each of the plurality of feeding couplers 108 may be connected to a respective feeding node of the plurality of feeding nodes. A feeding coupler may be configured to carry electrical signals to the radiator 104 during transmission of electromagnetic waves (e.g. mmW), or carry electrical signals from the radiator 104 during receiving of electromagnetic waves (e.g. mmW).

In various embodiments, the plurality of feeding couplers 108 may be feeding probes or vias. In various embodiments, the plurality of feeding couplers 108 may be coaxial connectors.

Each of the plurality of feeding couplers 108 may be connected directly or indirectly to a waveguide, e.g. a co-planar waveguide (CPW). For instance, a first end of a feeding coupler 108 may be connected directly to the radiator 104, and a second end of the feeding coupler 108 may be connected to a substrate integrated waveguide (SIW), which in turn may be coupled to a CPW (via a CPW-SIW transition).

The plurality of feeding nodes may be arranged in a configuration such that the plurality of feeding couplers 108 is configured to excite the radiator to achieve a full-range switched beam pattern.

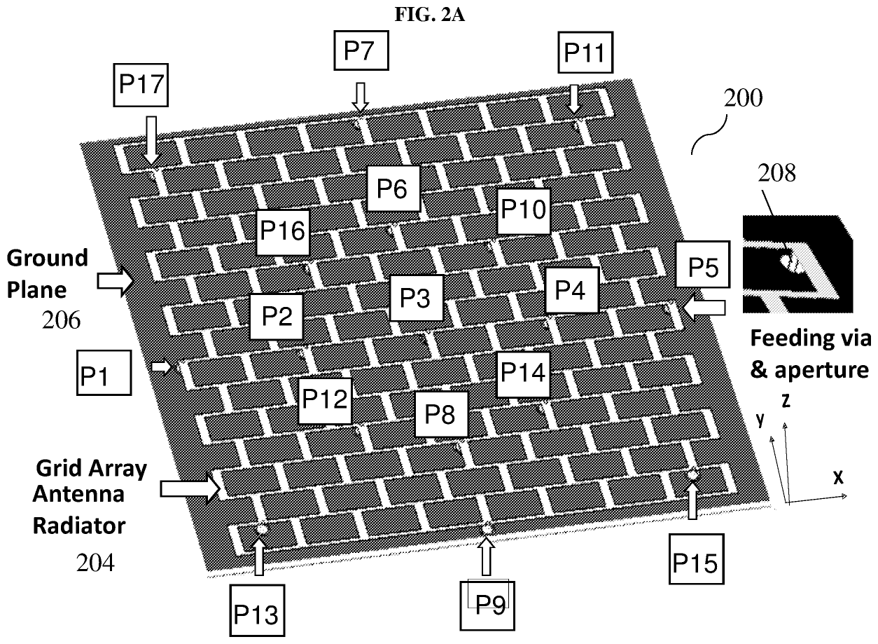

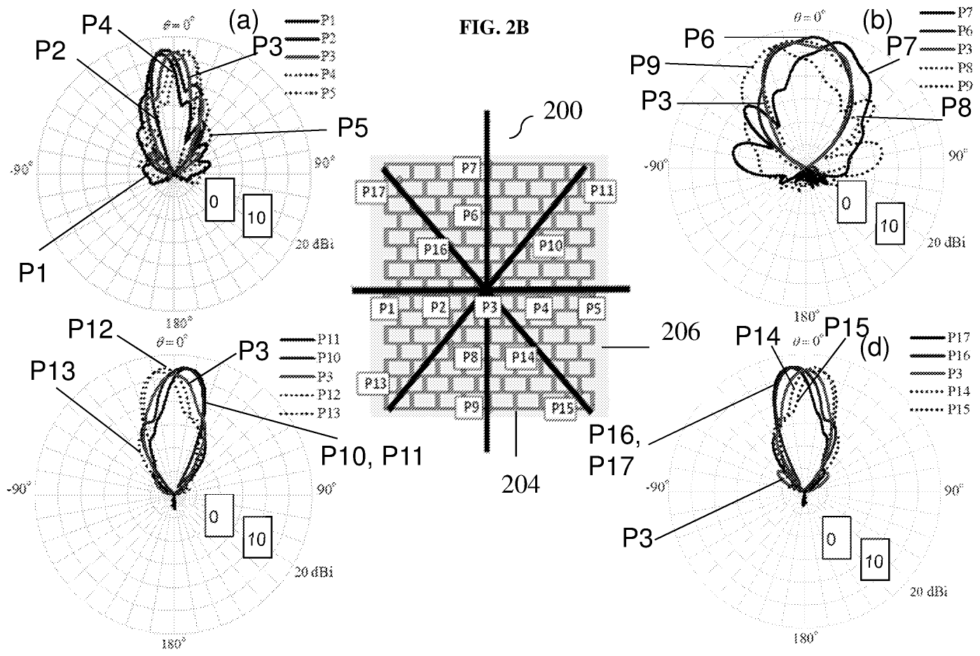

FIG. 2A shows an antenna 200 with 17 feeding nodes according to various embodiments. The inset of FIG. 2A shows a feeding probe 208, e.g. a feeding via, connected to a feeding node of the radiator 204. The feeding node may pass through an aperture of the ground structure 206, which may also be referred to as the ground plane. In various embodiments, the plurality of feeding couplers (or feeding probes) may be 17 feeding couplers (or feeding probes). In other words, the total number of feeding couplers in an antenna may be 17. In various other embodiments, the antenna may include or consist of any suitable number of feeding couplers, e.g. 3.

As seen from FIG. 2A, the feeding probes 208 may be allocated to feeding nodes, such that the allocated probes 208 may be labelled port 1 to port 17 (P1-P17). When a feeding probe provides the node connected to the feeding probe with excitation current, the current at the node may also be non-zero. However, when a feeding probe does not provide the node connected to the feeding probe with excitation current, the current at the node may be zero. Accordingly, at a point in time during operation, some of the nodes may be at “current zero”. The coupling of the feeding couplers 208 to these feeding nodes may not affect the performance of the antenna, which may provide the possibility of using multiple feeding to achieve a full-range switched beam coverage.

The central feeding node P3 or the central feeding coupler may allow the antenna 200 to generate the boresight beam.

The excitations from ports P1 and P2 may generate tilted beams directed to negative x-direction while the excitations from ports P4 and P5 will generate tilted beams directed to positive x-direction. Taken together, the ports P1 to P5 may be able to generate beams with specific coverage along x-axis (ϕ=0°).

Similarly, the ports P3/P6/P7/P8/P9 may cover y-direction (ϕ=90°) and the ports P3/P10/P11/P12/P13/P14/P15/P16/P17 may provide the coverage along the diagonal directions (ϕ=45°/−45°), respectively. A specific coverage may be realized by arranging the feeding ports/couplers properly.

In various embodiments, a first group of the plurality of feeding nodes or feeding couplers 208 may lie along a first line. A second group of the plurality of feeding nodes or feeding couplers 208 may lie along a second line perpendicular to the first line. A third group of the plurality of the feeding nodes or feeding couplers 208 may lie along a third line at an angle 45° between the first line and the second line. A fourth group of the plurality of feeding nodes or feeding couplers may lie along a fourth line perpendicular to the third line. The fourth line may also be at an angle 45° between the first line and the second line. The third line and the fourth lines may be diagonal lines extending between the first line and the second line. A central feeding node of the plurality of feeding nodes (or a central feeding coupler of the plurality of feeding couplers 208) may be at an intersection between the first line, the second line, the third line, and the fourth line.

FIG. 2B shows the two-dimensional (2-D) radiation patterns of the antenna 200 with 17 feed ports according to various embodiments at 93 GHz.

In one implementation, the radiator 200 may positioned on the top surface of the upper substrate (0.2 mm thick Ferro A6M, permittivity, ϵᵣ=5.9, loss tangent tan S=0.002) and may be fed by feeding probes through the ground apertures. As shown in (a) of FIG. 2B, the ports P1 to P5 may be able to generate 5 beams with specific coverage along x-axis (ϕ=0°). The 3-dB beam span of the combined five beams is ±12.2° using the peak directivity of 17.2 dBi as a reference.

Similarly, the ports P3/P6/P7/P8/P9 may cover y-direction (0=90°) beam scanning as shown in (b) of FIG. 2B. The 3-dB beam span of the combined five beams is ±26° using the peak directivity of 18.3 dBi as a reference. (c) of FIG. 2B shows the coverage along the diagonal direction with ϕ=45° using the ports P3/P10/P11/P12/P13. The 3-dB beam span of the combined five beams is −13.1° to 15.5° using the peak directivity of 17.3 dBi as a reference. The ports P3/P14/P15/P16/P17 provide the coverage along the diagonal direction with ϕ=−45° as shown in (d) of FIG. 2B. The 3-dB beam span of the combined five beams is −15.5° to 13.1° using the peak directivity of 17.3 dBi as a reference. It is noted that the asymmetrical beam scanning coverage arises due to the GAA asymmetrical excitations. In summary, 17 beams may be generated within the solid angles θ<14.1° and θ<26.3° with the directivity range of 15.3 dBi-18.3 dBi.

As shown in FIGS. 2A-B, the plurality of grid cells may be arranged in a rectangular staggered pattern. Alternatively, the plurality of grid cells may be arranged in a circular, parallelogram, square, rhombus, or any other suitable patterns. Each grid cell of the plurality of grid cells may include a first electrically conductive bar (or line), a second electrically conductive bar (or line) joined to a first end of the first electrically conductive bar (or line) and perpendicular to the first electrically conductive bar (or line), a third electrically conductive bar (or line) joined to a second end of the first electrically conductive bar (or line) and perpendicular to the first electrically conductive bar (or line), and a fourth electrically conductive bar (or line) having a first end joined to the second electrically conductive bar (or line) and a second end joined to the third electrically conductive bar (or line). A bar (or line) of a grid cell may be shared with a neighbouring grid cell. The size of each grid cell may be ˜λg×λg/2 (λg is the guided wavelength at the operating frequency).

In various embodiments, the plurality of feeding couplers 208 may include coaxial connectors. At lower frequency bands, the radiator 204 may be fed by using a coaxial connector directly. A coaxial connector may include an inner conductor and an outer conductor surrounding the inner conductor. The inner conductor of a coaxial connector may be connected to the feeding node of the GAA radiator on a top surface of the substrate, and the outer conductor of the coaxial connector may be connected to the ground structure 206.

In various embodiments, the antenna 200 may further include a plurality of substrate integrated waveguide (SIW) feeding structures, each of the plurality of substrate integrated waveguide feeding structure connected to a respective feeding coupler 208 of the plurality of feeding couplers. The respective coupler 208 may connect the SIW feeding structure to the radiator 204.

The plurality of feeding couplers 208 may be SIW-probe and aperture transitions, e.g. feeding vias. A substrate integrated waveguide (SIW) feeding structure may be connected to the radiator 204 via a SIW-probe and aperture transition or a feeding via. SIW feeding structures may be suitable for millimeter waves at 93 GHz because of the reduced transmission line loss.

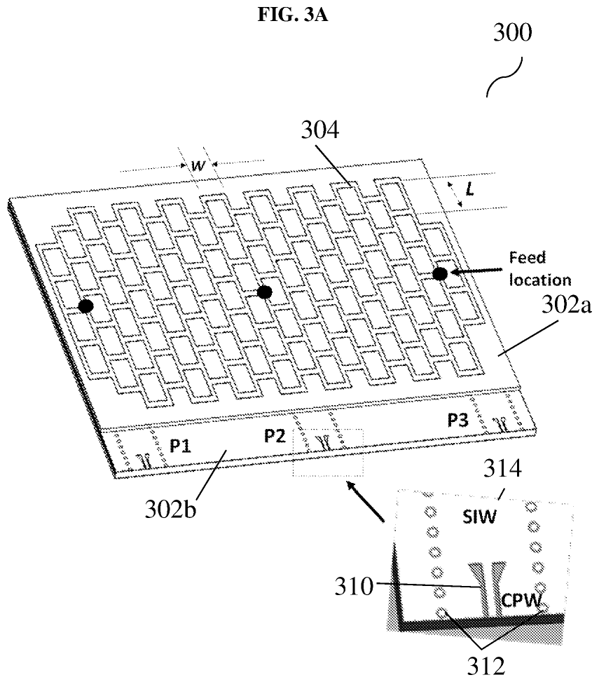

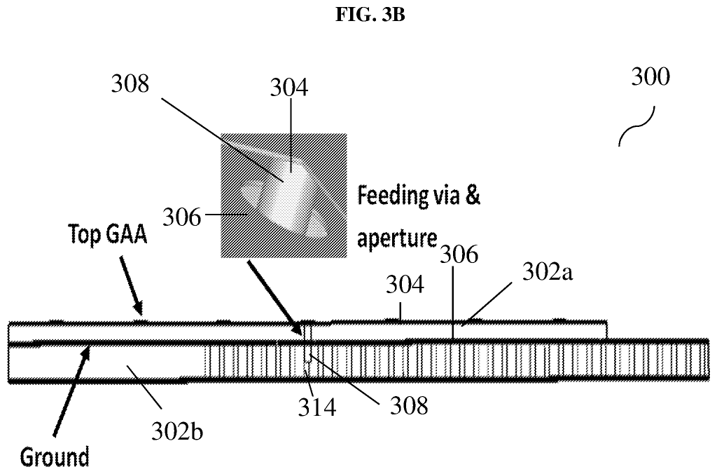

FIG. 3A shows an antenna 300 using substrate integrated waveguide (SIW) feeding structures 314 according to various embodiments. The inset of FIG. 3A shows a schematic of a substrate integrated waveguide (SIW) feeding structure 314 according to various embodiments. FIG. 3B is a cross-sectional view of the antenna 300 shown in FIG. 3A according to various embodiments. The inset of FIG. 3B shows a schematic of a feeding coupler 308, e.g. a feeding via, according to various embodiments. For simplicity, only the 1-D switched beam is illustrated in FIG. 3A-B.

The antenna 300 may include ports P1, P2 and P3. The antenna 300 may include a substrate 302a, and a further substrate 302b below the substrate 302a. The substrate 302a may be also be referred to as an upper substrate, while the further substrate 302b may be referred to as a lower substrate. The upper substrate 302a may include a suitable dielectric. The lower substrate 302b may also include a suitable dielectric. The upper substrate 302a and the lower substrate 302b may include the same material. In various embodiments, the upper substrate 302a and/or the lower substrate 302b may be hydrocarbon/ceramics composite substrates. In various other embodiments, the upper substrate 302a and/or the lower substrate 302b may be polytetrafluoroethylene (PTFE)/ceramics composite substrates. In yet various other embodiments, the upper substrate 302a and/or the lower substrate 302b may include air, wood, glass, liquid crystal polymer, or any other suitable materials.

The grid array radiator 304 (total size of 19.1 mm×12.95 mm, L=2.1 mm, W=1.05. mm, line width 0.35/0.2 mm) may be positioned on the top surface of the upper substrate 302a (19.8 mm×15 mm×0.2 mm Rogers RO4003C, permittivity, ϵᵣ=3.38, loss tangent, tan δ=0.0027). The plurality of feeding structures 314 may be in the lower substrate 302b (19.8 mm×17.55 mm×0.4 mm Rogers RO4003C). The ground structure 306 may be between the substrate 302a and the further substrate 302b.

For measurement purpose, the antenna interface may be chosen to be the co-planar waveguide (CPW) 310, which may have a line width of 0.17 mm and a spacing of 0.05 mm. The signal may be fed to the SIW 314 by using a CPW-SIW transition, and finally fed to the radiator 304 through an SIW-probe and aperture transition, e.g. a feeding via 308. The SIW 314 may have a width of 1.68 mm. A via-array 312 may be applied to implement the side wall of the SIW 314. The via-array 312 may include a plurality of vias. The via radius may be of 0.0762 mm and the inter-via spacing may be of 0.3556 mm.

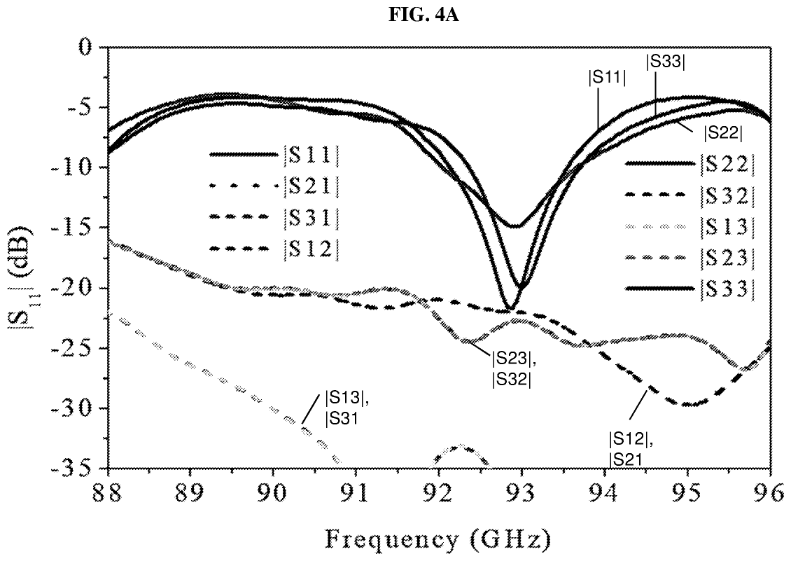

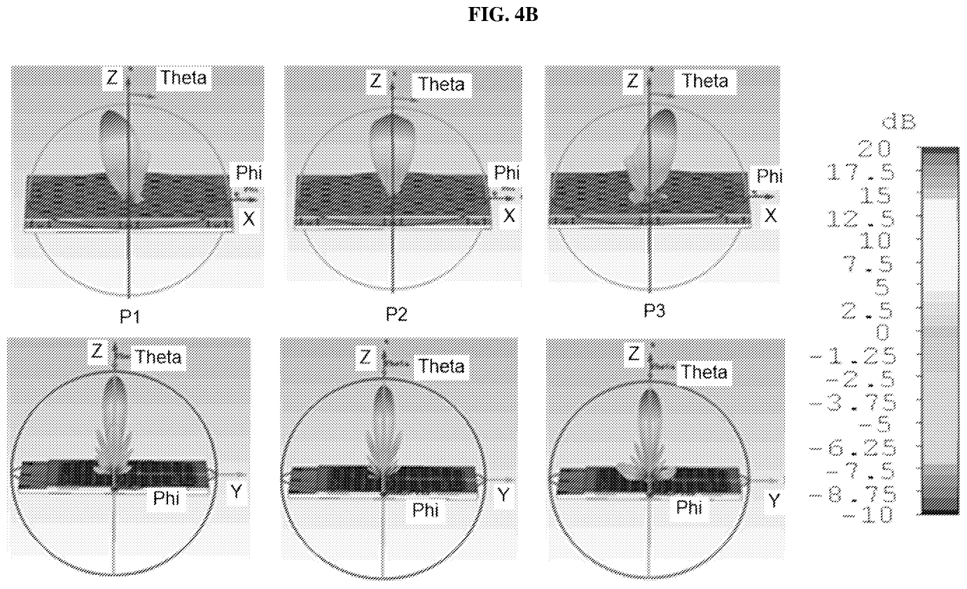

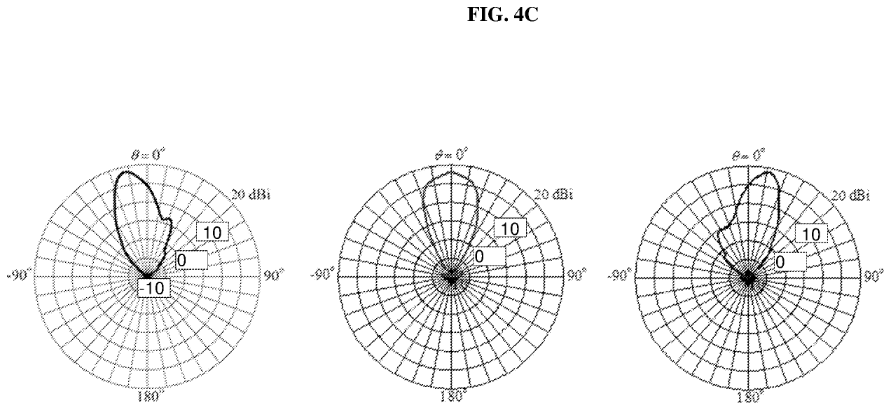

FIG. 4A shows a plot of a scattering parameter (S-parameter, in decibels or dB) as a function of frequency (in gigahertz or GHz) showing the simulated performance of the antenna shown in FIGS. 3A-B according to various embodiments. The reflection coefficient at 93 GHz is less than −19.6 dB, −14.7 dB, and −20 dB for port 1, port 2, and port 3, respectively. The isolation between the three ports is better than 22 dB at 93 GHz.

FIG. 4B shows 3-dimensional (3-D) radiation patterns for different ports of the antenna shown in FIGS. 3A-B according to various embodiments at 93 GHz. As expected, the switched beams may be realized along the x-axis direction while the beams may direct to boresight without any change along the y-axis direction.

FIG. 4C shows 2-dimensional (2-D) radiation patterns (with realized gain values) of the antenna shown in FIGS. 3A-B according to various embodiments in the xz-plane at 93 GHz. The maximum radiation from the port 1 points to −12° with a peak realized gain of 18.6 dBi, a 3-dB beamwidth of 16.5° and a side lobe of −12 dB. The radiation from the port 2 points to 0° with a peak realized gain of 17.9 dBi, a 3-dB beamwidth of 30.5° and a side lobe of −24.5 dB. The radiation from the port 3 points to 11° with a peak realized gain of 18.7 dBi, a 3-dB beamwidth of 16.4° and a side lobe of −14 dB. Using the peak realized gain of 18.7 dBi as a reference: the 3-dB beam span of the combined three beams is ±19°. It is noted that the linear polarization may be realized for all beams with cross polarization levels lower than −33 dB.

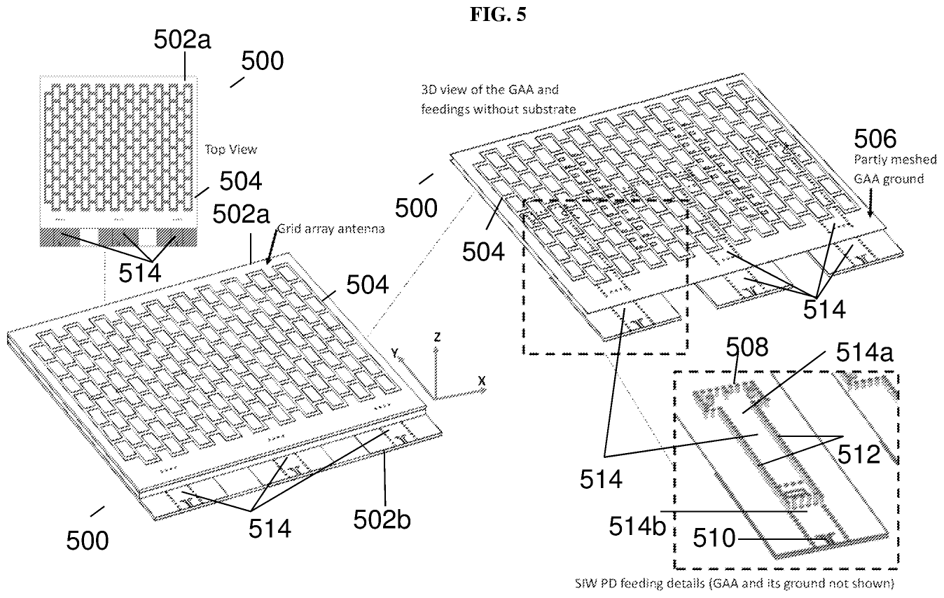

FIG. 5 shows a top view and a three-dimensional (3-D) view of an antenna 500 using substrate integrated waveguide (SIW) power divider (PD) feeding structures 514a according to various embodiments. In various embodiments, the feeding structures 514 may include SIW power divider (PD) feeding structures 514a, which may provide broadband high gains. The feeding structures 514 may also include SIW feeding structures 514b connected to the SIW PD feeding structures 514a. For simplicity, only the 1-D beam scanning is presented. The grid array radiator 504 (total size of 21.2 mm×17.15 mm, L=2.1 mm, W=1.05. mm, line width 0.35/0.2 mm) may positioned on the top surface of the upper substrate 502a (22.5 mm×20.6 mm×0.2 mm Rogers RO4003C, permittivity, ϵᵣ=3.38, loss tangent, tan δ=0.0027). The feeding structures 514 may be designed on the lower substrate 502b (22.5 mm×23 mm×0.6 mm Rogers RO4003C). For measurement purpose, the antenna interface may be chosen to be a co-planar waveguide (CPW) 510, which may have a line width of 0.15 mm and a spacing of 0.05 mm. The signal may be fed to the 0.2 mm thick SIW 514b by using a CPW-SIW transition, and may then be fed to the upper 0.4 mm thick SIW PD 514a through an aperture, and may finally be fed to the radiator 504 of the GAA 500 through two SIW-via & aperture transitions 508 in the ground plane 506. The SIW 514b may have a width of 1.7 mm. A via-array 512 applied to implement the side wall of the SIW 514b. The via radius may be 0.0762 mm and the inter-via spacing may be 0.3556 mm.

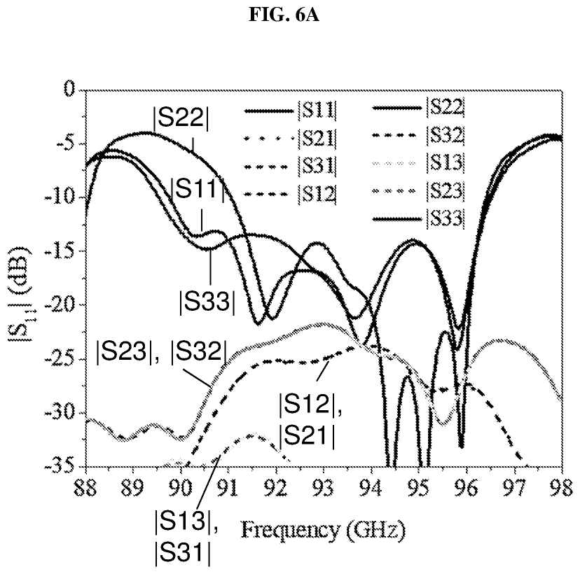

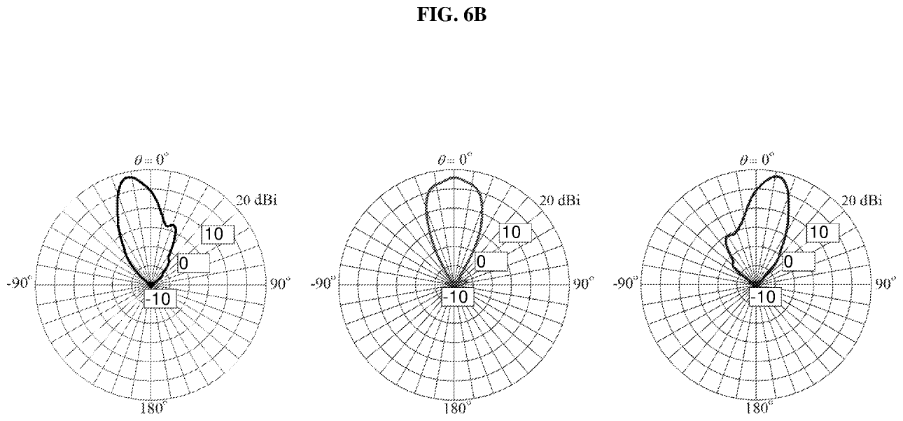

FIG. 6A shows a plot of a scattering parameter (S-parameter, in decibels or dB) as a function of frequency (in gigahertz or GHz) showing the simulated performance of the antenna shown in FIG. 5 according to various embodiments. Broadband impedance matching may be achieved. The −10-dB |S11| bandwidth of the three ports are 6.7 GHz (89.8 GHz-96.5 GHz), 5.4 GHz (91.1 GHz-96.5 GHz), and 7.0 GHz (89.5 GHz-96.5 GHz), respectively. The isolation between the three ports may be greater than 21.8 dB at 93 GHz. It is found from the simulation that the switched beams may be realized along the x-axis direction while the beams may direct to boresight without any change along the y-axis direction.

FIG. 6B shows 2-dimensional (2-D) radiation patterns (with realized gain values) of the antenna shown in FIG. 5 according to various embodiments in the xz-plane at 93 GHz. The maximum radiation from port 1 points to −10° with a peak realized gain of 20.1 dBi, a 3-dB beamwidth of 20.7° and a side lobe of −20.7 dB. The radiation from port 2 points to 2° with a peak realized gain of 20.1 dBi, a 3-dB beamwidth of 17.8° and a side lobe of −18.6 dB. The radiation from port 3 points to 11° with a peak realized gain of 20.4 dBi, a 3-dB beamwidth of 14.6° and a side lobe of −13.7 dB. Using the peak realized gain of 20.4 dBi as a reference; the 3-dB beam span of the combined three beams is from −16.8° to +15.2°. It is noted that the asymmetrical coverage and 2° deviation in the boresight radiation may be due to the asymmetrical GAA structure.

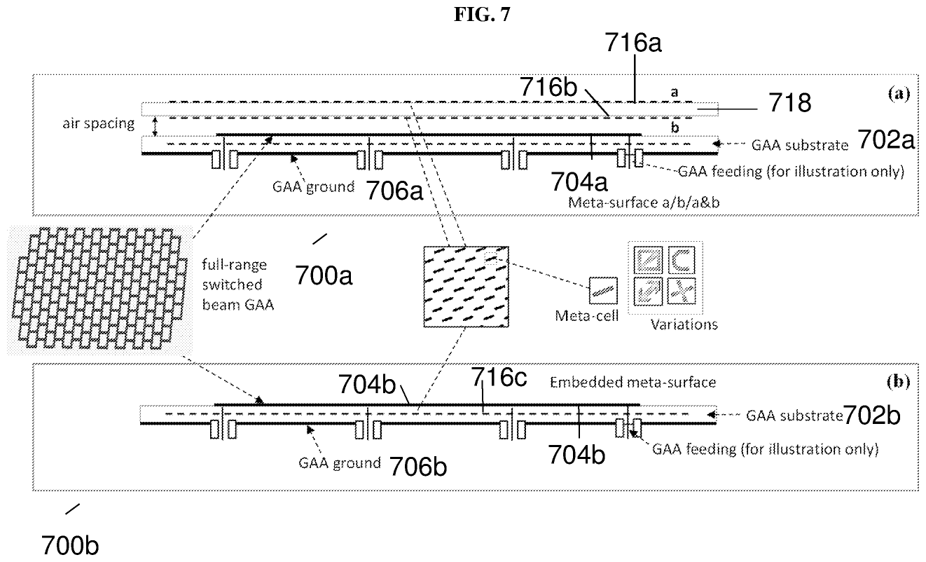

In various embodiments, the antenna may include a plurality of metamaterial cells forming a meta-surface. FIG. 7 shows (a) an antenna 700a including one or more meta-surfaces 716a, 716b on top of the radiator 704a according to various embodiments, and (b) an antenna 700b including an embedded meta-surface 716c between the radiator 704b and the ground structure or plane 706b according to various embodiments.

The meta-surface 716a-c or the plurality of metamaterial cells may be configured to convert linearly polarized waves emitted by the radiator 704a, 704b into circularly polarized (CP) waves. The meta-surface 716a-c or the plurality of metamaterial cells may be configured to couple the linearly polarized waves emitted by the radiator 704a, 704b, and may emit the circularly polarized (CP) waves based on or in response to the coupled linearly polarized waves.

The antenna 700a may include a suspended substrate 718 above the radiator 704a or substrate 702a. The suspended substrate 718 may be separated or spaced from the radiator 704a or substrate 702a by an air gap. The suspended substrate 718 may be held above the radiator 704a or substrate 702a by spacers or via any suitable means.

The meta-surface 716a, 716b or the plurality of metamaterial cells may be in contact with a surface of the suspended substrate 718.

In various embodiments, the antenna 700a may include the meta-surface 716a on or in contact with the surface of the suspended substrate 718 that is facing away from the radiator 704a or substrate 702a.

In various other embodiments, the antenna 700a may include the meta-surface 716b on or in contact with the surface of the suspended substrate 718 that is facing towards the radiator 704a or substrate 702a.

In yet various other embodiments, the antenna 700a may include both the meta-surface 716a on or in contact with the surface of the suspended substrate 718 that is facing away from the radiator 704a or substrate 702a, and the meta-surface 716b on or in contact with the surface of the suspended substrate 718 that is facing towards the radiator 704a or substrate 702a. In other words, the antenna 700a may include a plurality of metamaterial cells in contact with a surface of the suspended substrate, and may further include a plurality of further metamaterial cells forming a further meta-surface in contact with a further surface of the suspended substrate opposite the surface of the suspended substrate.

The antenna 700a may also include ground structure or ground plane 706a. As shown in FIG. 7(a), the ground plane 706a and the radiator 704a may be on opposing surfaces of the substrate 702a. The radiator 706a may be on or in contact with a first surface of the substrate 702a and the ground structure 706a may be on or in contact with a second surface of the substrate opposite the first surface of the substrate.

As highlighted above, the meta-surface 716a-b or the plurality of metamaterial cells may act as a polarizer that converts the linearly polarized radiation emitted by the radiator 704a into circularly polarized (CP) radiation.

The antenna 700b may include a meta-surface 716c or plurality of metamaterial cells embedded in the substrate 702b between the radiator 704b and the ground structure or ground plane 706b. The radiator 704b and the ground plane 706b may be on opposing surfaces of the substrate 702b. The embedded meta-surface may be configured to convert the linearly polarized radiation emitted by the radiator 704b into circularly polarized (CP) radiation.

In the antennas 700a, 700b, CP full-range switched beaming functions may be realized in a much more compact format. As shown in FIG. 7, each metamaterial cell (or meta-cell) may be a rotated strip. As illustrated in FIG. 7, each metamaterial cell may alternatively be of other shapes such as ‘c’ shape etc. In various embodiments, each of the plurality of metamaterial cells may be a strip structure, a c-shaped structure, a cross-shaped structure, a double ended arrow structure, or a diagonal square structure. In addition, the meta-cells may be uniformly distributed or may be non-uniformly distributed. In various embodiments, the plurality of metamaterial cells may include any suitable material. For instance, each metamaterial cell may be a composite structure including a metal and a dielectric.

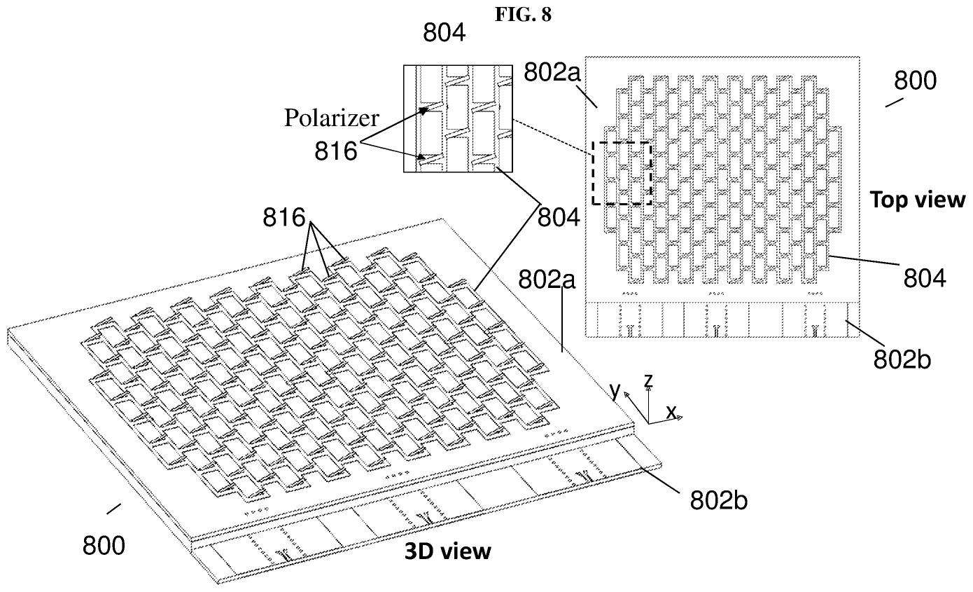

FIG. 8 shows the top view and the 3-dimensional (3-D) view of an antenna 800 for emitting circularly polarized (CP) beams according to various embodiments. For simplicity only the 1-D scanning is illustrated.

As shown in FIG. 8, the polarizer 816 may be located on the top of the radiator 804. The spacing distance, s, between the polarizer 816 and the radiator 804 may be 0.2 mm. It is noted that the polarizer may be in contact with a surface of a 0.25 mm Rogers RO3003 substrate (not shown in FIG. 8, permittivity, ϵᵣ=3, loss tangent, tan δ=0.001) facing the radiator 804. The radiator 804 may be on a surface of the substrate 802a, while the ground plate (not indicated in FIG. 8) may be between substrate 802a and further substrate 802b.

The polarizer 816 may include a plurality of plurality of metamaterial cells. As shown in FIG. 8, each metamaterial cell may be directly above the second electrically conductive bar or the third electrically conductive bar (i.e. a lateral bar) of a grid cell.

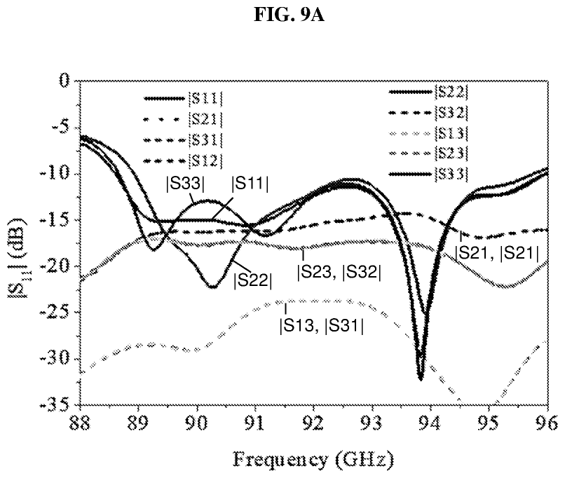

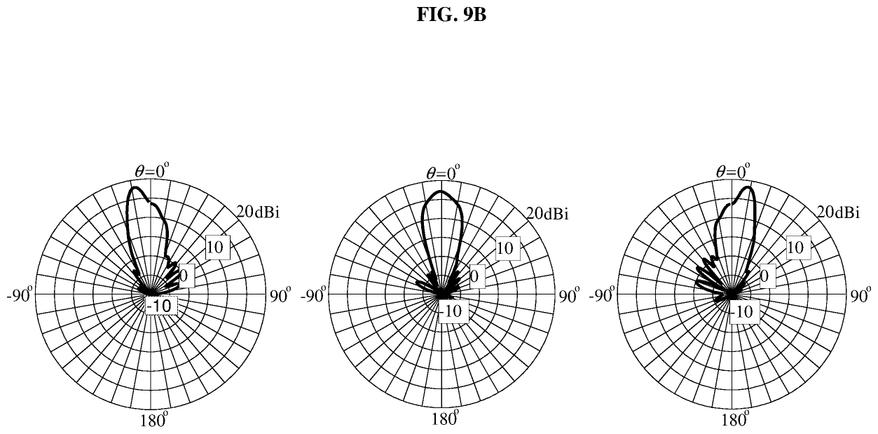

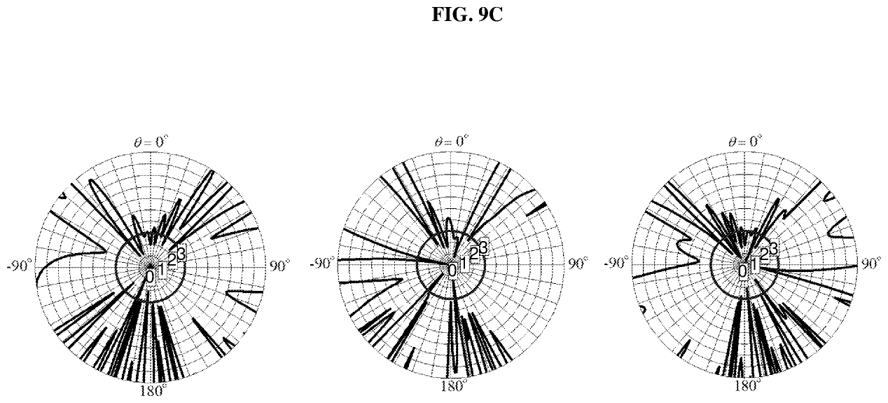

FIG. 9A shows a plot of a scattering parameter (S-parameter, in decibels or dB) as a function of frequency (in gigahertz or GHz) showing the simulated performance of the antenna shown in FIG. 8 according to various embodiments. The impedance matching at 93 GHz is good with |S11| less than −12.3 dB, −11.3 dB, and −12 dB for port 1, port 2, and port 3, respectively. The isolation between the three ports is greater than 14 dB at 93 GHz.

As expected, the switched beams may be realized along the x-axis direction while the beams may be directed to boresight without any change along the y-axis direction.

FIG. 9B shows 2-dimensional (2-D) radiation patterns (with realized gain values) of the antenna shown in FIG. 8 according to various embodiments in the xz-plane at 93 GHz. The maximum radiation from port 1 points to −9° with a peak realized gain of 18 dBi, a 3-dB beamwidth of 10.9° and a side lobe of −17.2 dB. The radiation from port 2 points to 0° with a peak realized gain of 17.1 dBi, a 3-dB beamwidth of 20.1° and a side lobe of −19.8 dB. The radiation from the port 3 points to 9° with a peak realized gain of 18.3 dBi, a 3-dB beamwidth of 10.1° and a side lobe of −16.6 dB. Using the peak realized gain of 18 dBi as a reference; the 3-dB beam span of the combined three beams is ±13.8°.

FIG. 9C shows the axial ratio pattern of the antenna shown in FIG. 8 according to various embodiments in the xz-plane at 93 GHz.

It may be noted from FIG. 9C that the CP radiation is realized for all beams with axial ratio lower than 4.1 dB across the 3-dB beam coverage.

Various embodiments may relate to an antenna. The antenna may include a substrate. The antenna may further include a radiator in contact with the substrate, the radiator including a plurality of grid cells. The antenna may also include a ground structure spaced from the radiator, the ground structure including a plurality of apertures. The antenna may additionally include a plurality of feeding couplers connected to the radiator, each of the plurality of feeding couplers passing through a respective aperture of the plurality of apertures.

The radiator may include a plurality of feeding nodes. Each of the plurality of feeding couplers may be connected to a respective feeding node of the plurality of feeding nodes.

In various embodiments, a first group of the plurality of feeding nodes may lie along a first line. A second group of the plurality of feeding nodes may lie along a second line perpendicular to the first line. A third group of the plurality of the feeding nodes may lie along a third line at an angle 45° between the first line and the second line. A fourth group of the plurality of feeding nodes may lie along a fourth line perpendicular to the third line.

A central feeding node of the plurality of feeding nodes may be at an intersection between the first line, the second line, the third line, and the fourth line.

The plurality of feeding nodes may be arranged in a configuration such that the plurality of feeding couplers is configured to excite the radiator to achieve a full-range switched beam pattern.

A grid cell of the plurality of grid cell may include a first electrically conductive bar, a second electrically conductive bar joined to a first end of the first electrically conductive bar and perpendicular to the first electrically conductive bar, a third electrically conductive bar joined to a second end of the first electrically conductive bar and perpendicular to the first electrically conductive bar, and a fourth electrically conductive bar having a first end joined to the second electrically conductive bar and a second end joined to the third electrically conductive bar.

In various embodiments, the radiator may be on a first surface of the substrate and the ground structure may be on a second surface of the substrate opposite the first surface of the substrate.

In various embodiments, the antenna may further include a further substrate below the substrate. The ground structure may be between the substrate and the further substrate. The ground structure is configured to be connected to ground (0 V). The ground structure may be a plate.

In various embodiments, the antenna may further include a plurality of substrate integrated waveguide (SIW) feeding structures, each of the plurality of substrate integrated waveguide feeding structures connected to a respective feeding coupler of the plurality of feeding couplers.

A SIW feeding structure may be defined or at least partially be defined by a via-array including a plurality of vias.

The plurality of feeding couplers may also include a plurality of feeding vias or feeding probe. A feeding via or probe may pass through an aperture of the ground structure, and may connect a SIW feeding structure with the radiator.

In various embodiments, the plurality of feeding couplers may include coaxial connectors.

In various embodiments, the plurality of feeding couplers may include 17 feeding couplers.

In various embodiments, the antenna may also include a plurality of metamaterial cells forming a meta-surface or a polarizer. The meta-surface or the polarizer may include the plurality of metamaterial cells.

Each of the plurality of metamaterial cells may be of any suitable shape and/or size. In various embodiments, each of the plurality of metamaterial cells may be a strip structure, a c-shaped structure, a cross-shaped structure, a double ended arrow structure, or a diagonal square structure.

The plurality of metamaterial cells may be configured to convert linearly polarized waves emitted by the radiator into circularly polarized (CP) waves.

In various embodiments, the plurality of metamaterial cells may be embedded in the substrate between the radiator and the ground structure.

In various other embodiments, the antenna may also include a suspended substrate above the radiator. The plurality of metamaterial cells may be in contact with a surface of the suspended substrate. The antenna may additionally include a plurality of further metamaterial cells forming a further meta-surface or polarizer in contact with a further surface of the suspended substrate opposite the surface of the suspended substrate.

The antenna may be devoid of a phase shifter.

Various embodiments may relate to a grid array antenna with a planar full-range circularly polarized switched beam capability. The grid array antenna include a plurality of feeding structures, each feeding structure connected to the grid antenna (or radiator) via a feeding probe (“port”), and/or feeding node/point at a predefined location on the grid array. The plurality of the feed probes and/or feeding node/point may be arranged in a configuration to excite the grid antenna to achieve a full-range switched beam pattern.

In various embodiments, the grid array antenna may further include a meta-surface having a plurality of equally spaced meta-cells disposed above the grid array antenna. The meta-surface may be separated from the radiator by an air gap, each meta-cell arranged above each intersecting grid element such that the meta-surface and grid array antenna interoperates to provide circularly polarized switched beams.

In various embodiments, the antenna may include substrate integrate waveguides (SIW). In various embodiments, the plurality of feeding couplers may include seventeen feeding ports (or feeding probes).

Various embodiments may relate to a grid array antenna for providing a full range coverage with single radiator without using any expensive phase shifter. Various embodiments may offer a fully integrated solution, with planar and low profile configuration. Various embodiments may have a low built cost.

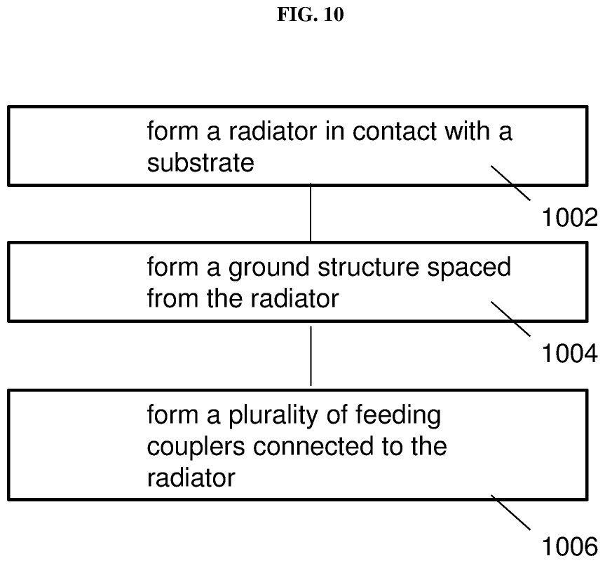

FIG. 10 is a schematic illustrating a method of forming an antenna according to various embodiments. The method may include, in 1002, forming a radiator in contact with a substrate, the radiator including a plurality of grid cells. The method may also include, in 1004, forming a ground structure spaced from the radiator, the ground structure including a plurality of apertures. The method may additionally include, in 1006, forming a plurality of feeding couplers connected to the radiator, each of the plurality of feeding couplers passing through a respective aperture of the plurality of apertures.

In other words, the method of forming an antenna may include forming a radiator and a ground structure separated from the radiator. The ground structure may have a plurality of apertures. The method may also include forming a plurality of feeding couplers passing through the apertures to connect to the radiator.

For avoidance of doubt, the steps shown in FIG. 10 may not necessarily be in sequence. For instance, step 1004 may occur before, after or at the same time with step 1002.

In various embodiments, the plurality of feeding couplers may include coaxial connectors.

In various embodiments, the plurality of feeding couplers may be feeding probes or feeding vias. The method may further include forming a plurality of substrate integrated waveguide (SIW) feeding structures, each of the plurality of substrate integrated waveguide feeding structures connected to a respective feeding coupler of the plurality of feeding couplers.

In various embodiments, the method may also include providing or forming a further substrate below the substrate. The ground structure is between the substrate and the further substrate.

In various embodiments, the method may also include forming or arranging a plurality of metamaterial cells forming a meta-surface or a polarizer.

In various embodiments, the plurality of metamaterial cells may be embedded in the substrate between the radiator and the ground structure.

In various other embodiments, the method may further include forming or providing a suspended substrate above the radiator. The plurality of metamaterial cells may be in contact with a surface of the suspended substrate. The method may also include forming or providing a plurality of further metamaterial cells forming a further meta-surface or polarizer in contact with a further surface of the suspended substrate opposite the surface of the suspended substrate.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An antenna comprising:
a substrate;
a radiator in contact with the substrate, the radiator comprising a plurality of grid cells;
a ground structure spaced from the radiator, the ground structure comprising a plurality of apertures; and
a plurality of feeding couplers connected to the radiator, each of the plurality of feeding couplers passing through a respective aperture of the plurality of apertures.

2. The antenna according to claim 1,
wherein the radiator comprises a plurality of feeding nodes; and
wherein each of the plurality of feeding couplers is connected to a respective feeding node of the plurality of feeding nodes.

3. The antenna according to claim 2,
wherein a first group of the plurality of feeding nodes lies along a first line;
wherein a second group of the plurality of feeding nodes lies along a second line perpendicular to the first line;
wherein a third group of the plurality of the feeding nodes lies along a third line at an angle 45° between the first line and the second line; and
wherein a fourth group of the plurality of feeding nodes lies along a fourth line perpendicular to the third line.

4. The antenna according to claim 3, wherein a central feeding node of the plurality of feeding nodes is at an intersection between the first line, the second line, the third line, and the fourth line.

5. The antenna according to claim 2, wherein the plurality of feeding nodes is arranged in a configuration such that the plurality of feeding couplers is configured to excite the radiator to achieve a full-range switched beam pattern.

6. The antenna according to claim 1, wherein a grid cell of the plurality of grid cell comprises:
a first electrically conductive bar;
a second electrically conductive bar joined to a first end of the first electrically conductive bar and perpendicular to the first electrically conductive bar;
a third electrically conductive bar joined to a second end of the first electrically conductive bar and perpendicular to the first electrically conductive bar; and
a fourth electrically conductive bar having a first end joined to the second electrically conductive bar and a second end joined to the third electrically conductive bar.

7. The antenna according to claim 1, wherein the radiator is on a first surface of the substrate and the ground structure is on a second surface of the substrate opposite the first surface of the substrate.

8. The antenna according to claim 1, further comprising:
a further substrate below the substrate;
wherein the ground structure is between the substrate and the further substrate.

9. The antenna according to claim 1, wherein the ground structure is a plate.

10. The antenna according to claim 1, wherein the ground structure is configured to be connected to ground.

11. The antenna according to claim 1, further comprising:
a plurality of substrate integrated waveguide (SIW) feeding structures, each of the plurality of substrate integrated waveguide feeding structures connected to a respective feeding coupler of the plurality of feeding couplers.

12. The antenna according to claim 1, wherein the plurality of feeding couplers comprises coaxial connectors.

13. The antenna according to claim 1, wherein the plurality of feeding couplers comprises 17 feeding couplers.

14. The antenna according to claim 1, further comprising:
a plurality of metamaterial cells forming a meta-surface.

15. The antenna according to claim 14, wherein each of the plurality of metamaterial cells is a strip structure, a c-shaped structure, a cross-shaped structure, a double ended arrow structure, or a diagonal square structure.

16. The antenna according to claim 14, wherein the plurality of metamaterial cells is configured to convert linearly polarized waves emitted by the radiator into circularly polarized (CP) waves.

17. The antenna according to claim 14, wherein the plurality of metamaterial cells is embedded in the substrate between the radiator and the ground structure.

18. The antenna according to claim 14, further comprising:
a suspended substrate above the radiator;
wherein the plurality of metamaterial cells is in contact with a surface of the suspended substrate.

19. The antenna according to claim 18, further comprising:
a plurality of further metamaterial cells forming a further meta-surface in contact with a further surface of the suspended substrate opposite the surface of the suspended substrate.

20. A method of forming the antenna, the method comprising:
forming a radiator in contact with a substrate, the radiator comprising a plurality of grid cells;
forming a ground structure spaced from the radiator, the ground structure comprising a plurality of apertures; and
forming a plurality of feeding couplers connected to the radiator, each of the plurality of feeding couplers passing through a respective aperture of the plurality of apertures.
